(19) United States
(12) Patent Application Publication
(10) Pub. No.: US 2005/0172935 A1
(43) Pub. Date: Aug. 11, 2005

(54) Common rail injection system comprising a variable injector and booster device

(76) Inventors: Hans-Christoph Magel, Pfullingen (DE); Andreas Kellner, Tamm (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/517,401

(22) PCT Filed: Apr. 3, 2003
(86) PCT No.: PCT/DE03/01099

(30) Foreign Application Priority Data
Jun. 29, 2002 (DE) 102 29 417.8

(51) Int. Cl. F02M 1/00

(52) U.S. Cl. 123/446

(57) ABSTRACT

A fuel injection system for internal combustion engines in which a high-pressure fuel source supplies fuel to a fuel injector and a pressure booster disposed between an injection valve and the high-pressure fuel source has a booster piston which separates a pressure chamber which can be connected to the high-pressure fuel source from a high-pressure chamber that acts upon a nozzle chamber of the fuel injector. The injection valve includes a nozzle needle having a first nozzle needle part and a second nozzle needle part which being triggered as a function of pressure open and close various injection cross sections of an injection nozzle.

### FIELD OF THE INVENTION

For supplying combustion chambers of self-igniting internal combustion engines, both pressure-controlled and stroke-controlled injection systems may be employed. Examples of fuel injection systems that can be used are not only unit fuel injectors and pump-line-nozzle units but also reservoir-type injection systems (common rails). Common rails for instance advantageously make it possible to adjust the injection pressure to the engine load and rpm. In general, if high specific performance and a reduction in emissions are to be attained, the highest possible injection pressure is needed.

### BACKGROUND OF THE INVENTION

For reasons of strength, the attainable pressure level in reservoir-type injection systems (common rails) used at present is currently limited to about 1600 bar. To further increase the pressure in reservoir-type injection systems, a pressure booster can be employed in common rail systems. European Patent Disclosure EP 0 562 046 B1 discloses an actuation and valve assembly with damping for an electronically controlled injection unit. The actuation and valve assembly for a hydraulic unit has an electrically excitable electromagnet assembly with a fixed stator and a movable armature. The armature has a first and a second surface. The first and second surfaces of the armature define a first and second high-pressure chamber, and the first surface of the armature points toward the stator. A valve is provided which is connected to the armature. The valve is capable of carrying a hydraulic actuating fluid from a sump to the injection system. With respect to one of the high-pressure chambers of the electromagnet assembly, a damping fluid can be accumulated there or drained off from there. By means of a region of a valve needle that protrudes into a central bore, the fluidic communication of the damping fluid can be opened or closed selectively, in proportion to the viscosity of the fluid.

German Patent Disclosure DE 101 23 910.6 relates to a fuel injection system. This fuel injection system is used in an internal combustion engine. The combustion chambers of the engine are supplied with fuel via fuel injectors. The fuel injectors are acted upon via a high-pressure source; the fuel injection system also includes a pressure booster, which has a movable pressure booster piston that divides a chamber which can be connected to the high-pressure source from a chamber that communicates with the fuel injector. The fuel pressure in the high-pressure chamber can be varied by filling a differential pressure chamber of the pressure booster device with fuel or by emptying fuel from the differential pressure chamber of the fuel booster.

The fuel injector includes a movable closing piston for opening and closing injection openings. The closing protrudes into a closing pressure chamber, so that the closing piston can be acted upon by pressure by means of fuel. As a result, a force urging the closing piston in the closing direction is achieved. The closing pressure chamber and a further chamber are formed by a common work chamber, and all the portions of the work chamber communicate permanently with one another for the exchange of fuel.

With this embodiment, by triggering the pressure booster via the differential pressure chamber, it can be attained that the triggering losses in the high-pressure fuel system can be kept markedly smaller, in comparison to triggering via a work chamber that communicates intermittently with the high-pressure fuel source. Moreover, the high-pressure chamber is relieved only as far as the pressure level of the high-pressure reservoir, rather than down to the leak fuel level. On the one hand, this improves the hydraulic efficiency, and on the other, there can be a faster pressure buildup to the peak pressure level, so that the time intervals between injection phases can be shortened.

Because of ever more stringent requirements in terms of emissions and noise in self-igniting internal combustion engines, further provisions are needed in the injection system in order to meet the more stringent limit values expected in the near future.

### SUMMARY OF THE INVENTION

In the fuel injector, embodied according to the invention, with a pressure booster, a further improvement in emissions values and noise performance of a self-igniting internal combustion engine can be attained by using a Vario injection nozzle. As a result of the use of a pressure booster, which acts upon a nozzle chamber of the injection nozzle with fuel that is at high pressure, on the one hand a very high injection pressure can be attained, and on the other, the use of a Vario injection nozzle makes it possible to open injection cross sections of various sizes.

With a multi-part nozzle needle embodied according to the invention, the injection of fuel via two different injection cross sections, embodied on the end toward the combustion chamber of the fuel injector, can be achieved. To that end, the injection openings are advantageously designed as concentric circles of holes, which advantageously promote fuel atomization. At a low injection pressure, the injection of fuel takes place via an injection cross section uncovered by a first nozzle needle part. If the injection pressure is increased further, then injection can be done via an additional injection cross section, which is then opened by a further nozzle needle part. Via the injection cross section opened by the first nozzle needle part, a smaller quantity of fuel, at a lower injection pressure, reaches the combustion chamber. This promotes the mixture preparation in the combustion chamber of the self-igniting internal combustion engine in the context of a boot phase. If a pre-settable switching pressure is exceeded, the second nozzle needle part opens, so that in addition to the injection cross section that is uncovered by the first nozzle needle part, a greater quantity of fuel reaches the combustion chamber of the engine as a result of the opening of a further injection cross section at a higher pressure level. The gas contained in the combustion chamber can be prepared in a way that promotes the course of combustion by means of a previous boot injection.

The provisions of the invention make it possible to inject extremely small fuel quantities with short injection durations and to inject greater fuel quantities over longer injection durations; optionally, even relatively small pilot injections can be realized with the provisions proposed according to the invention. Small pilot injections improve the noise behavior of a self-igniting internal combustion engine. Moreover, by the use of very small preinjection quantities into the combustion chamber of the self-igniting engine, an improvement in exhaust gas emissions is achieved. With the provisions of the invention, noise improvement in self-igniting internal combustion engines can be attained so that “knocking” can be maximally prevented by the shaping of the injection rate.

### DRAWING

The invention is described in further detail below in conjunction with the drawing.

Shown are:

FIG. 1, the hydraulic circuit diagram of a fuel injector with a pressure booster, a Vario injection nozzle, and a coaxial nozzle needle, in a first variant embodiment;

FIG. 2, the hydraulic circuit diagram of a fuel injector with a pressure booster and a Vario injection nozzle and with a closing chamber acted upon directly via a high-pressure reservoir;

FIG. 3, the pressure courses in the nozzle chamber, high-pressure chamber and closing chamber, the needle stroke lengths, and the flow cross sections established in accordance with the needle strokes at the nozzle in the variant embodiment of a fuel injector of FIG. 2; and

FIG. 4, a further variant embodiment of a fuel injector with a pressure booster and a Vario nozzle with optimized reference leakage.

### VARIANT EMBODIMENTS

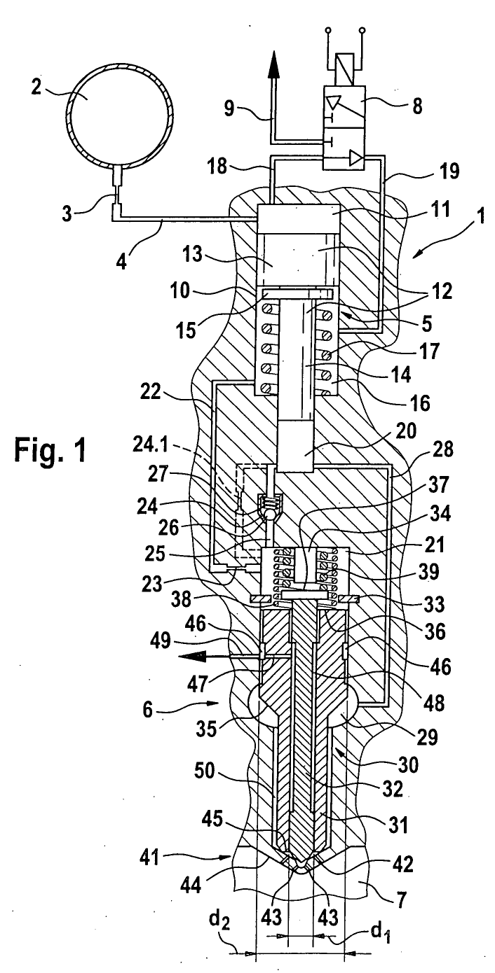

FIG. 1 shows the hydraulic circuit diagram of a fuel injector with a pressure booster, Vario injection nozzle, and coaxial nozzle needle, whose closing chamber can be acted upon with fuel from the differential pressure chamber of the pressure booster.

The fuel injection system shown in FIG. 1 includes a fuel injector 1, which is supplied with fuel at high pressure via a high-pressure reservoir 2 (common rail). Besides the high-pressure reservoir 2, the fuel injection system includes the fuel injector 1, a pressure booster 5, and the injection valve identified by reference numeral 6, by way of which fuel is injected into a combustion chamber 7, shown only schematically here, of a self-igniting internal combustion engine, on the end of the injection valve 6 toward the combustion chamber.

From the high-pressure reservoir 2 shown schematically in FIG. 1, fuel passes via a first throttle restriction 3 and an adjoining line 4 into a pressure chamber 11 of the pressure booster 5. Besides the aforementioned pressure chamber 11, the pressure booster 5 includes a differential pressure chamber 16. A piston 12, embodied as an axially displaceable graduated piston, is received inside the pressure booster 5 and includes a first partial piston 13, embodied with a larger diameter than a second partial piston 14 to make guidance possible. The piston 12 may either comprise two separate components or be made as a single component. In the exemplary embodiment of FIG. 1, an attachment 15 embodied in the form of a disk is provided between the first partial piston 13 and the second partial piston 14. This attachment is acted upon by a restoring spring 17, which is received in the differential pressure chamber 16 and is braced, with its end opposite the attachment 15, on the housing bottom of the pressure booster 5. The second partial piston 14, with its face end, defines a high-pressure chamber 20 of the pressure booster, by way of which, among other elements, a high-pressure line 28 branches off that subjects a nozzle chamber 29 of the injection valve 6 to fuel that is at very high pressure.

From the pressure chamber 11 of the pressure booster 5, a line 18 branches off to a control valve, embodied as a magnet valve 8, which in the variant embodiment shown in FIG. 1 of the fuel injection system proposed by the invention is embodied as a magnet valve. In the basic state shown in FIG. 1, the lead line 18 from the pressure chamber 11 of the pressure booster is in communication with a fuel line 19, by way of which the differential pressure chamber 16 of the pressure booster 5 is acted upon by fuel. From the differential pressure chamber 16, in the variant embodiment of the fuel injection system shown in FIG. 1, a differential pressure chamber line 22 leads to a closing chamber 21 in the upper region of the injection valve 6. In the basic state of the fuel injection system shown in FIG. 1, the pressure prevailing in the high-pressure reservoir 2 is present via the line 4 in the pressure chamber 11 of the pressure booster 5, at the magnet valve 8, via the fuel line 19 at the differential pressure chamber 16 of the pressure booster, and via the differential pressure chamber line 22 in the closing chamber 21 of the injection valve 6. Via a check valve 24, preceding the high-pressure chamber 20, the pressure of the high-pressure reservoir 2 is present in both the high-pressure chamber 20 and the nozzle chamber 29.

For the sake of completeness, it should be noted that besides the lead line 18 from the pressure chamber 11 and the fuel lead line 19 to the differential pressure chamber 16, a low-pressure-side return 9 branches off from the magnet valve 8 in the variant embodiment in FIG. 1, and in it, the control volume upon switching of the magnet valve 8 into a further switching position flows away into a fuel container, not shown in FIG. 1.

The check valve 24, which is disposed upstream of the high-pressure chamber 20 of the pressure booster 5, includes a closing body 26, embodied here as a ball, which in turn is acted upon via a spring element 27. Instead of a check valve 24 between the high-pressure chamber 20 of the pressure booster 5 and the closing chamber 21, a throttle restriction 24.1 may also be received in the line 25—as indicated in suggested fashion in FIG. 1—through which throttle restriction the pressure medium, that is, the fuel, can flow in both directions.

The injection valve 6 shown in FIG. 1, in the variant embodiment of the fuel injection system proposed by the invention, includes a coaxial nozzle needle 30, which contains a first nozzle needle part 31 and a second nozzle needle part 32. The nozzle needle parts 31 and 32 are guided inside one another and are actuatable independently of one another. The first nozzle needle part 31 is movable up and down vertically inside the housing of the injection valve 6. The stroke limitation of the first nozzle needle part 31 is provided by an annular stop 33 let into the closing chamber 21 of the injection valve 6. By means of the annularly embodied stop 33 in the closing chamber 21, the maximum stroke length is specified to and limited for the first nozzle needle part 31. Moreover, the closing chamber 21 of the injection valve 6 includes a pinlike stop 34, which serves as stroke limitation for the second nozzle needle part 32, coaxially guided in the first nozzle needle part 31, of the coaxial nozzle needle 30. In the variant embodiment of FIG. 1, a disklike stop face 37 is embodied in the upper region of the second nozzle needle part 32; it cooperates with the stop 34, acting as a stroke limitation, disposed inside the closing chamber 21 and predetermines the vertical motion of the second nozzle needle part 32 inside the housing of the injection valve 6.

Inside the closing chamber 21 of the injection valve 6 in the variant embodiment of FIG. 1, both the first nozzle needle part 31 and the second nozzle needle part 32 are acted upon by a respective spring element 38 and 39. The spring element 38 that acts on the first nozzle needle part 31 is braced on a face end 36 of the first nozzle needle part 31, while the spring element 39, surrounding the pinlike stop 34, rests on the face end 37 of the second nozzle needle part 32. The closing chamber 21 shown in FIG. 1 is acted upon by fuel from the differential pressure chamber 16 of the pressure booster 5 via the differential pressure chamber line 22; in the region of its orifice into the closing chamber 21, the differential pressure chamber line 22 may contain a throttle restriction 23. The line 25 discharging from the check valve 24 into the closing chamber 21 can discharge into the closing chamber 21; instead of the check valve 24 integrated with the line 25 as in FIG. 1, the throttle restriction 24.1 shown in suggested fashion in FIG. 1 may also be let into the line 25, between the high-pressure chamber 20 of the pressure booster 5 and the closing chamber 21.

The first nozzle needle part 31, shown in FIG. 1, of the coaxial nozzle needle 30 includes a hydraulically effective surface area 35, which in the embodiment shown is embodied such that it extends conically in the form of a pressure shoulder 35. The pressure shoulder 35 on the outer circumferential surface of the first nozzle needle part 31 is entirely surrounded by the nozzle chamber 29 of the injection valve 6. From the nozzle chamber 29 of the injection valve 6, an annular gap 50 extends as far as the end toward the combustion chamber of the injection valve 6. The second nozzle needle part 32 likewise includes a hydraulically effective surface area 40 in the form of a pressure shoulder, which is embodied on the end toward the combustion chamber of the second nozzle needle part 32. In accordance with the design of the hydraulically effective surface area 40 on the end toward the combustion chamber of the second nozzle needle part 32 and the design of the spring element 39 acting on the second nozzle needle part 32, a switching pressure at which the inner nozzle needle part 31 of the coaxial nozzle needle 30 opens as shown in FIG. 1 can be set to suit the dimensioning.

A conical face 44 on which injection openings are embodied is embodied on the end toward the combustion chamber of the injection valve 6. In the variant embodiment of the injection valve 6 of the fuel injection system in FIG. 1, the nozzle of the injection valve 6 embodied as a Vario injection nozzle 41, includes a first injection cross section 42 as well as a further, second injection cross section 43. In a preferred embodiment of the provisions of the invention, the first injection cross section 24 and the second injection cross section 43 are both embodied as rows of holes, for instance as concentric circles of holes, and include many extremely small bores, by way of which during the injection of fuel into the combustion chamber 7—shown only schematically here—a fine atomization of the fuel is attained during the injection operation, and this in turn assures a favorable course of combustion in terms of emissions values and noise production. In the variant embodiment in FIG. 1, the first injection cross section 42 is uncovered upon opening of the first nozzle needle part 31, when the nozzle chamber 29 is acted upon by high pressure. An injection of fuel takes place only via the first injection cross section 42 on the end 44 toward the combustion chamber of the injection valve 6. Depending on the dimensioning of the hydraulically effective surface area 40—here designed as a pressure shoulder—and as a function of the dimensioning of the spring element 39 that acts on the second nozzle needle part 32, the second nozzle needle part 32 of the coaxial nozzle needle 30 opens at a defined switching pressure and in addition to the first injection cross section 42 uncovers the further, second injection cross section 43. In this switching state—with both nozzle needle parts 31 and 32 open—fuel is injected both via the first injection cross section 42 and additionally via the further, second injection cross section 43, uncovered by the first nozzle needle part 31, into the combustion chamber 7 of the self-igniting internal combustion engine.

The reference leakage, established at the high pressures because the nozzle needle parts 31 and 32 of the coaxial nozzle needle 30 that are guided inside one another, is delivered via a recess 48, which may for instance be embodied as an annular groove toward the outer circumference of the second nozzle needle part 32, via a conduit 47, which penetrates the first nozzle needle part 31, into a further annular groove 46, which surrounds the aforementioned annular groove and in turn communicates toward the housing with a leak fuel conduit 49. Hence the reference leakage can be carried into the low-pressure region of the fuel injection system via the leak fuel line 49, analogously to the low-pressure-side return 9 that is associated with to the magnet valve 8.

While the hydraulically effective surface area 35 on the outer circumference of the first nozzle needle part 31 is surrounded by the nozzle chamber 29, the hydraulic surface area 40, embodied as a pressure shoulder, on the chamber that closes the second nozzle needle part 32 is formed on the one hand by the face end 45 of the first nozzle needle part 31 and on the other by the nozzle body face 44 of the injection valve 6 protruding conically into the combustion chamber 7 of the self-igniting engine.

The mode of operation of the variant embodiment of the invention shown in FIG. 1 is as follows: Via the line 4, the pressure prevailing in the high-pressure reservoir 2 is present at the fuel injector 1. In the basic state shown in FIG. 1, the magnet valve 8 is not triggered, and no injection is taking place. Accordingly, the pressure prevailing in the high-pressure reservoir 2 is present both in the pressure chamber 11 of the pressure booster 5 and at the aforementioned magnet valve 8. Furthermore, the pressure prevailing in the high-pressure reservoir 2 is present in the differential pressure chamber 16 of the pressure booster 5, via the magnet valve 8 that has been switched open and via the fuel line 19. Moreover, the rail pressure prevails in the closing chamber 21 of the injection valve 6, via the differential pressure chamber line 22 and the throttle restriction 23 received in it, and flows from the closing chamber 21 of the injection valve 6 in the opening direction of the check valve 24 into the high-pressure chamber 20 of the pressure booster 5. From the high-pressure chamber 20 of the pressure booster 5, the fuel in turn flows via the high-pressure line 28 into the nozzle chamber 29 of the injection valve 6. Accordingly, in the basic state, all the pressure chambers 11, 16 and 20 of the pressure booster 5 are acted upon by the pressure level prevailing in the high-pressure reservoir 2, and the partial pistons 13 and 14 of the pressure booster 5 are in pressure equilibrium. In this basic state of the system shown in FIG. 1, the pressure booster 5 is deactivated, and no pressure boosting takes place. In this state, the piston 12 of the pressure booster 5 is moved, via the restoring spring 17 associated with it, into its outset position, in which filling of the high-pressure chamber 20 of the pressure booster 5 is effected from the closing chamber 21 of the injection valve 6, via the check valve 24. By means of the pressure prevailing in the closing chamber 21, a hydraulic closing force on the nozzle needle part 31 and 32 of the coaxially embodied nozzle needle 30 is built up. In addition, the first nozzle needle part 31 and the second nozzle needle part 32 are urged into the closing position via the spring elements 38 and 39 disposed in the closing chamber 21. The pressure level prevailing in the high-pressure reservoir 2 can therefore prevail constantly, via the high-pressure line 28, in the nozzle chamber 29 of the injection valve 6, without the first nozzle needle part 31 opening in response to the pressure action of the fuel on the pressure shoulder 35. Only when the pressure in the nozzle chamber 29 rises above the pressure prevailing in the high-pressure reservoir 2, which happens because the pressure booster 5 is switched on, does the first nozzle needle part 31 open and the injection begin.

The metering of the fuel is effected by means of a pressure relief of the differential pressure chamber 16 of the pressure booster 5. This is attained by providing that the magnet valve 8 is activated, and as a result, fuel flows from the differential pressure chamber 16 via the fuel line 19 out into the low-pressure-side outlet 9, so that the differential pressure chamber 16 of the pressure booster 5 is cut off from the system pressure supply. As a result, the pressure in the differential pressure chamber 16 of the pressure booster 5 drops, causing the pressure booster 5 to be activated, and the pressure in the nozzle chamber 29 rises, since the activated pressure booster 5 causes an increase in the pressure in the high-pressure chamber 20, by way of which the nozzle chamber 29 is acted upon by fuel. As a result, at the hydraulic surface area 35 of the first nozzle needle part 31—embodied here as a pressure shoulder—an opening force oriented counter to the spring force 38 ensues, causing the first nozzle needle part 31 to move vertically upward. The high pressure prevails in the nozzle chamber 29 until such time as the differential pressure chamber 16 is pressure-relieved into the low-pressure-side outlet 9 via the switched magnet valve 8. Because of the pressure relief of the differential pressure chamber 16, the closing chamber 21 of the injection valve 6 is also relieved, via the line 22, into the differential pressure chamber 16 of the pressure booster 5, which in turn is relieved via the aforementioned line 19 to the low-pressure side 9 of the fuel injection system. As long as the differential pressure chamber 16 of the pressure booster 5 is pressure-relieved, the pressure booster 5 remains activated and compresses the fuel in the high-pressure chamber 20. The compressed fuel is carried via the nozzle chamber 29 along the annular gap 50 to the first injection cross section 42, which is uncovered as a result of the vertical upward motion of the first nozzle needle part 31, so that the fuel flowing in via the annular gap 50 is injected via the first injection cross section 42 into the combustion chamber 7 of the self-igniting engine. As a result of the pressure relief of the differential pressure chamber 16 of the pressure booster 5, the closing chamber 21 of the injection valve 6 is pressure-relieved.

In this state, that is, with the first nozzle needle part 31 opened and with the injection of fuel via the first injection cross section 42, the injection pressure is likewise present at the needle tip of the second nozzle needle part 32, which is guided coaxially in the first nozzle needle part 31. As a result, an opening pressure force acts on the hydraulic face, embodied as a pressure shoulder 40, at the tip of the second nozzle needle part 32. Since the closing chamber 21 of the injection valve 6 is pressure-relieved, the spring element 39 acts as a closing force on the second nozzle needle part 32. By way of the dimensioning of the pressure shoulder 40 on the end toward the combustion chamber of the second nozzle needle part 32 and by way of the spring 39, a switching pressure can be set beyond which the second nozzle needle part 32, guided coaxially in the first nozzle needle part 31, opens and uncovers the further, second injection cross section 43 associated with it. Accordingly, at a pressure level that is below the settable switching pressure of the second nozzle needle part 32, the first nozzle needle part 31 can also be opened and as a result the first injection cross section 42 can be uncovered, while the second nozzle needle part 32 remains closed. In this state, an injection of fuel takes place via the first injection cross section 42. At an injection pressure that is above the settable switching pressure, both the first nozzle needle part 31 and the second nozzle needle part 32 open, because the spring force acting on the latter is less than the hydraulic force that acts on it on the end toward the combustion chamber, that is, on the pressure shoulder 40, of the second nozzle needle part 32. Above the settable switching pressure, an injection into the combustion chamber 7 of the self-igniting engine takes place via both the first injection cross section 42 and the further, second injection cross section 43.

For terminating the injection, the magnet valve 8 is switched so that the differential pressure chamber 16 of the pressure booster 5 and closing chamber 21, communicating with the differential pressure chamber 16 via the line 22, are both disconnected from the low-pressure side 9 of the magnet valve 8. As a result, the differential pressure chamber 16 is acted upon via the lead line 18 from the pressure chamber 11 of the pressure booster 5 by the pressure level prevailing in the high-pressure reservoir 2, so that once again the rail pressure level builds up in the differential pressure chamber 16. As a consequence, the pressure in the high-pressure chamber 20 of the pressure booster 5 drops to the pressure level prevailing in the high-pressure reservoir 2. Since the pressure level prevailing in the high-pressure reservoir 2 now also prevails in the closing chamber 21 of the injection valve 6, both the first nozzle needle part 31 and the second nozzle needle part 32 of the coaxial nozzle needle 30 are in pressure equilibrium. Because of the action on the first nozzle needle part 31 and the second nozzle needle part 32 by respective spring elements 38 and 39, the nozzle needle parts 31, 32 of the coaxial nozzle needle 30 are put in their closing position. This terminates the injection. The closing speed at which the first nozzle needle part 31 and the second nozzle needle part 32 are pressed into their closing positions can be varied by way of the inlet throttle restriction 23, which is received in the differential pressure chamber line 22 from the differential pressure chamber 16 to the closing chamber 21 of the injection valve 6. Once the pressure equilibrium has been brought about, the piston 12, including both a first partial piston 13 and a partial piston 14, in a one-piece or separate embodiment, is returned to its outset position by the restoring spring 17. For carrying away leakage flows through the needle guides, a relief 46, 47, 48 into a leak fuel line 49 is provided at the coaxial nozzle needle 30 in the variant embodiment of the invention in FIG. 1, and by way of this line the reference leakage can be carried away to the low-pressure region of the fuel injection system.

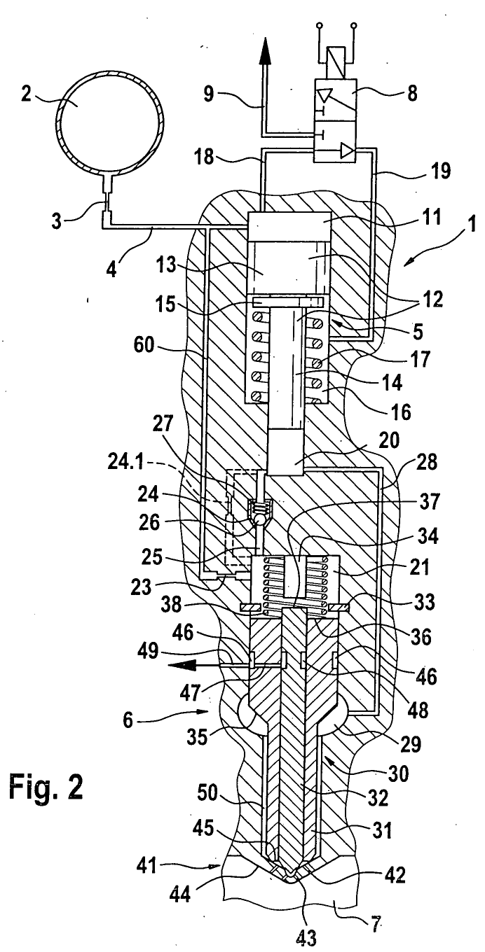

FIG. 2 shows the hydraulic circuit diagram of a fuel injector with a pressure booster, a Vario injection nozzle, and a closing chamber, which can be acted upon directly via a high-pressure reservoir, of an injection valve of the fuel injector.

The variant embodiment of the invention shown in FIG. 2 differs from the variant shown in FIG. 1 in that the closing chamber 21 of the injection valve 6 can be acted upon directly, via a high-pressure branch 60 branching off from the line 4, by the pressure level prevailing in the high-pressure reservoir 2, bypassing the magnet valve 8 and the differential pressure chamber 16 of the pressure booster 5. A further distinction from the variant embodiment of FIG. 1 is that in the variant embodiment of the invention shown in FIG. 2, only the first nozzle needle part 31 of the coaxial nozzle needle 30 is acted upon by a spring element 38, functioning as a closing spring, on the face end 36. Otherwise, the variant embodiment shown in FIG. 2 is identical to the variant embodiment of the invention that has already been described in conjunction with FIG. 1.

In the basic state shown in FIG. 2, the magnet valve 8, which may also be embodied as a piezoelectric actuator or may be a directly controlled valve or a servo valve, is switched in such a way that the pressure prevailing in the pressure chamber 11 of the pressure booster 5, which is equivalent to the pressure in the high-pressure reservoir 2, also prevails in the differential pressure chamber 16 via the fuel line 19. In addition, the pressure level in the high-pressure reservoir 2 is present in the closing chamber 21 of the injection valve 6 via the line 7 the branch 60. Via the check valve line 25, beginning at the closing chamber 21, the high-pressure chamber 20 of the pressure booster 5 is acted upon by the rail pressure level, that is, the pressure level that prevails in the high-pressure reservoir 2. Via the high-pressure line 28, which begins at the high-pressure chamber 20 of the pressure booster 5, the pressure level prevailing in the high-pressure reservoir 2 moreover prevails in the nozzle chamber 29 of the injection valve 6 as well.

The metering of the fuel to the end toward the combustion chamber of the injection valve 6 is effected by means of a pressure relief of the differential pressure chamber 16 of the pressure booster 5, by activation of the magnet valve 8, embodied for instance as a 3/2-way valve. The differential pressure chamber 16 is as a result disconnected from the system pressure subjection and is made to communicate with the low-pressure line 9, which begins at the magnet valve 8. As a result, the pressure in the differential pressure chamber 16 drops, causing the pressure booster 5 to be activated; that is, because of the pressure prevailing in the pressure chamber 11, which is equivalent to the pressure level of the high-pressure reservoir 2, the piston 12 moves downward, causing the pressure in the high-pressure chamber 20 and, via the high-pressure line 28, in the control chamber 29 of the injection valve 6 as well to rise. As a result, the hydraulic force acting on the first nozzle needle part 31, that is, on its pressure shoulder 35, increases, and the nozzle needle 31 moves vertically upward; however, inside the closing chamber 21 of the injection valve 6, a stroke limitation 33 is provided, which limits the maximum vertical stroke of the first nozzle needle part 31. The first nozzle needle part 31 is designed such that its opening ensues whenever a first opening pressure p_{ö,1} is reached in the nozzle chamber 29. As long as the differential pressure chamber 16 of the pressure booster 5 remains pressure-relieved, the pressure booster 5 is activated. The pressure in the nozzle chamber 29 and at the tip of the second nozzle needle part 32 is increased in the further course of injection, up to a maximum pressure level pₘₐₓ. If the level of the injection pressure reaches a second opening pressure p_{ö,2}, the second nozzle needle part 32 opens, and as a result the further, second injection cross section 43 is opened, and an injection of fuel into the combustion chamber 7 of the self-igniting engine is now effected both via the first injection cross section 42, which is uncovered by the first nozzle needle part 31, and via the further, second injection cross section 43, which is uncovered by the second nozzle needle part 32. The first opening pressure p_{ö,1} is determined essentially by the hydraulically effective surface areas, that is, by the design of the pressure shoulder 35 in the nozzle chamber 29 and the dimensioning of the end face 36 of the first nozzle needle part 31, and is thus directly proportional to the pressure level that prevails in the high-pressure reservoir 2. The second opening pressure p_{ö,2} is likewise determined essentially by the hydraulic pressure face 40 at the tip of the second nozzle needle part 32 and by the dimensioning of the end face 37 which points toward the closing chamber 21 of the injection valve 6. The second opening pressure p_{ö,2} is likewise proportional to the pressure level prevailing in the high-pressure reservoir 2.

For terminating the injection, the differential pressure chamber 16 of the pressure booster 5 is made by the magnet valve 8 to communicate with system pressure, that is, the high-pressure reservoir 2.

Because of the pressure building up in the differential pressure chamber 16 via the lines 19 and 18, the piston 12 of the pressure booster 5, reinforced by the restoring spring 17, moves into its outset position, and as a result the pressure in the high-pressure chamber 20 of the pressure booster 5 drops. As a result, the pressure in the nozzle chamber 29 of the injection valve 6 also drops to the rail pressure level, that is, the pressure level prevailing in the high-pressure chamber 2, and as a result the first nozzle needle part 31 and the second nozzle needle part 32 are hydraulically balanced. Because of the action on the first nozzle needle part 31 by the spring element 38 inside the closing chamber 21 of the injection valve 6, this valve is closed. The injection is terminated. As a result, the pressure force built up at the tip of the second nozzle needle part 32 collapses, so that the second nozzle needle part 32 is closed because of the pressure level now being established in the closing chamber 21 via the lines 4 and 60. The closing speed can be varied by way of the dimensioning of the throttle restriction 23, which precedes the closing chamber 21 and is received in the branch 60.

In the variant of FIG. 2 as well, recesses 46 and 48, embodied for instance as annular grooves, that divert the reference leakage are embodied on the coaxially embodied nozzle needle 30 between the telescoping nozzle needle parts 31 and 32; these recesses communicate with a leak fuel line 49, which returns the diverted reference leakage for instance into a fuel container not shown in further detail here.

In the variant embodiment of FIG. 2, the piston 12 of the pressure booster 5 can again be embodied in either a single part or in multiple parts. The restoring spring 17, which is received in the differential pressure chamber 16 of the pressure booster 5, can be disposed either in the pressure chamber 11 of the pressure booster 5 or in the high-pressure chamber 12 of the pressure booster 5.

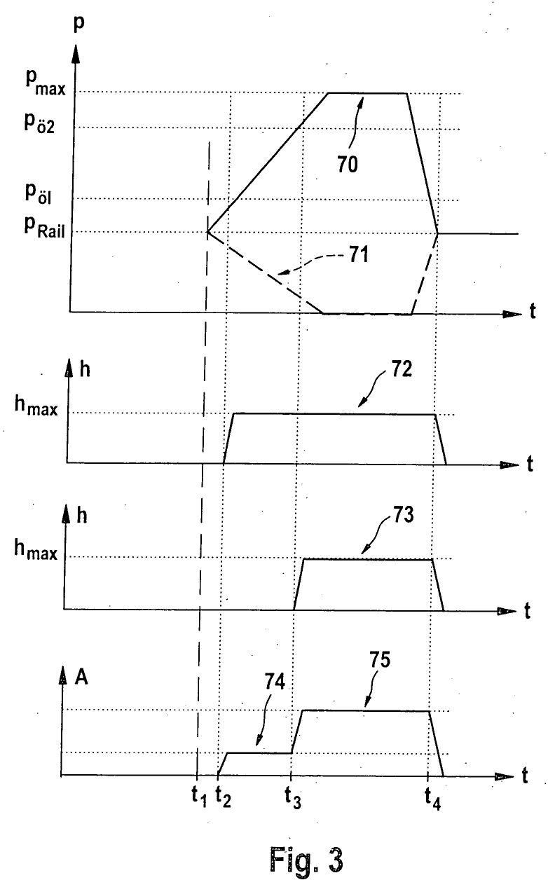

In FIG. 3, the pressure courses in the nozzle chamber, high-pressure chamber, and closing chamber, and the needle stroke motion and the flow cross sections at the Vario nozzle that are established in accordance with the needle stroke lengths are shown for the variant embodiment of FIG. 2.

At a time t₁, the rail pressure pᵣₐᵢₗ prevails in the high-pressure reservoir 2. At a second time, marked t₂, the first opening pressure p_{ö,1} is reached, so that the first nozzle needle part 31 opens in response to the hydraulic force acting on the pressure shoulder 35 of the first nozzle needle part 31 in the control chamber 29. At the first injection cross section, which is uncovered by the opening motion of the first nozzle needle part 31, a first injection quantity 74 is established, which during the opening phase between t₂ and t₃ of the first nozzle needle part 31 reaches the combustion chamber 7 of the self-igniting engine. Parallel to the pressure increase established in the nozzle chamber 29 or in the high-pressure chamber 20 of the pressure booster 5 (see curve course 70), the pressure in the differential pressure chamber 16 of the pressure booster 5 drops as represented by the curve course 71. If during the further pressure increase 70 from the first opening pressure p_{ö,1} to the second opening pressure p_{ö,2}, the switching pressure of the second nozzle needle part 32 is reached, then this nozzle needle part opens at a time t₃ (see bottom graph in FIG. 3). At switching time t₃, the first nozzle needle part 31, because of the hydraulic force acting in the nozzle chamber 29 on the hydraulic surface area 35, that is, the pressure shoulder, remains in its open position in accordance with the stroke course identified by reference numeral 72 and assumes its maximum stroke position hₘₐₓ, which is defined by the stop 33 embodied in the closing chamber 21. At time t₃, because the second opening pressure p_{ö,2} is being exceeded, the second nozzle needle part 32 opens as indicated by the stroke course represented by reference numeral 73. As a result, the quantity of fuel injected into the combustion chamber 7 of the self-igniting engine increases in accordance with the quantity identified by reference numeral 75; that is, in addition to the first injection cross section 42, uncovered by the first nozzle needle part 31, an injection of fuel now takes place into the combustion chamber 7 of the engine via not only the first injection cross section 42 but also the further, second injection cross section 43, which because of the stroke motion of the second nozzle needle part 32 is now uncovered. At time t₄, by means of the magnet valve 8, the differential pressure chamber 16 of the pressure booster 5 is again put in communication with the system pressure, so that in accordance with a pressure buildup in the differential pressure chamber 16, a pressure reduction ensues both in the control chamber 29 and in the high-pressure chamber 20 of the pressure booster 5, and accordingly, as described above, the opening pressures at the hydraulic surface areas 35 and 40 acting on the first nozzle needle part 31 and the second nozzle needle part 32, respectively, collapse, and the closing forces operative in the closing chamber 21, that is, the spring acting on the first nozzle needle part 31, and the pressure level, prevailing in the closing chamber 21 via the lines 4 and 60, of the first nozzle needle part 31 is moved into its closing position, as a result of which the injection is ended.

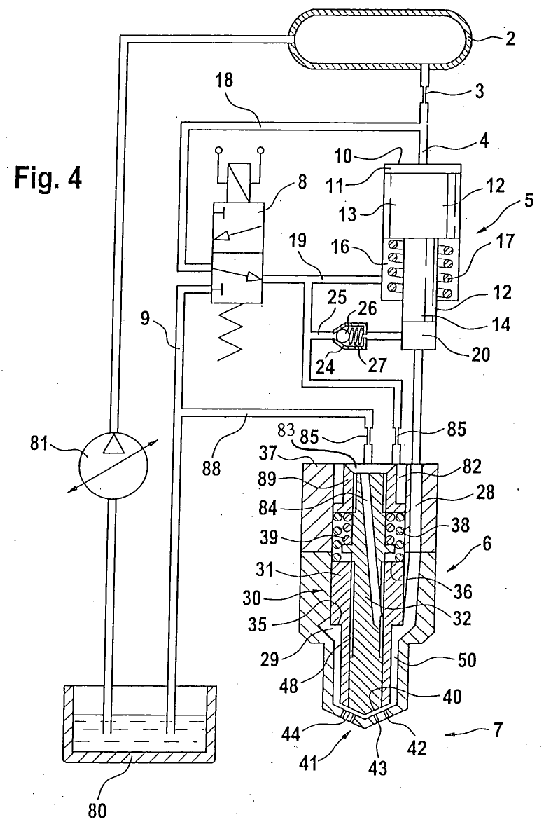

FIG. 4 shows a further variant embodiment of a fuel injector with a pressure booster and a Vario injection nozzle with optimized reference leakage.

From the variant embodiment shown in FIG. 4 it can be seen that a regulated high-pressure pump assembly 81 pumps fuel from a fuel container 80 into a high-pressure reservoir 2. From the high-pressure reservoir 2, the fuel that is at high pressure prevails in the pressure chamber 11 of the pressure booster 5 via a line 4 that includes the throttle restriction 3. From the line 4, upstream of the pressure chamber 11, a line 18 branches off by way of which the magnet valve 8 is acted upon. From the magnet valve 8, in the switching position shown in FIG. 4, the pressure level of the high-pressure reservoir 2 prevails in the differential pressure chamber 16 of the pressure booster 5, in which a restoring spring 17 is received, analogously to the variant embodiments of the version proposed by the invention as shown in FIGS. 1 and 2. The restoring spring 17 is braced on the housing in the differential pressure chamber 16 of the pressure booster 5 and acts upon a first partial piston 13, of larger diameter, of a two-part piston 12, which with its second partial piston region 14 acts upon a high-pressure chamber 20—analogously to what is shown in FIGS. 1 and 2.

From the magnet valve 8, analogously to what FIGS. 1 and 2 show, a low-pressure-side return 9 branches off, which discharges into the fuel container 80. The check valve 24, by way of which filling of the high-pressure chamber 20 of the pressure booster 5—assuming a switching position of the magnet valve 8 as shown in FIG. 4—is effected as also in the variant embodiment of the invention shown in FIG. 4, is received in a branch from the fuel line 19 to the differential pressure chamber 16 of the pressure booster 5.

The injection valve 6 in the variant embodiment of FIG. 4 includes a coaxial nozzle needle 30, which has a first nozzle needle part 31 and a further, inner nozzle needle part 32. The second, inner 32 of the coaxial nozzle needle 30 has an associated, separately pressure-relievable nozzle spring element 83, which can be pressure-relieved on the low-pressure side via the interposition of a throttle restriction 86 into the low-pressure lines 9 and from there into the fuel container. Via a lead line, including a further throttle restriction 85, from the high-pressure line 19 to the differential pressure chamber 16, a first nozzle spring element 82 that acts on the first nozzle needle part 31 is filled.

A sleevelike body 89 with a shoulder serves to seal off the second nozzle control chamber 83 from the first nozzle control chamber 82. The sleevelike body 89 is guided relative to the second nozzle needle part 32 in a manner that is proof against high pressure and has a flat sealing seat relative to the injector body. The sleevelike body 89 may be subjected to pressure from the first nozzle control chamber 82, which acts vertically upward to generate an additional sealing force.

Both the first spring element 38 and the second spring element 39 are braced on a sleevelike body 89 disposed coaxially to the first nozzle needle part 31. The spring element 39 associated with the second nozzle needle part 32 acts on a stop 87, embodied on the circumference of the second nozzle needle part 32, while the spring element 38 acts directly on the face end 36 of the first, outer nozzle needle part 31. The second nozzle needle part 32, for carrying away the reference leakage, is equipped with a longitudinal bore 84, by way of which a recess 48, provided on the outer circumference of the second nozzle needle part 32, communicates with the second nozzle spring element 83 that can be pressure-relieved to the low-pressure side.

In the basic state shown in FIG. 4, the pressure level in the pressure chamber 11 of the pressure booster 5 prevailing in the high-pressure reservoir 2 also prevails at the magnet valve 8 via the line in the differential pressure chamber 16 of the pressure booster 5 in the first nozzle spring element 82 of the injection valve 6 and, via the check valve 24, in the high-pressure chamber 20 of the pressure booster 5, as well as in the nozzle chamber 29 of the injection valve, which chamber can be acted upon by high pressure via the fuel lead line 28. The pressure-relievable second nozzle spring element 83 above the face end of the second nozzle needle part 32 commmunicates directly with the return 9 into the fuel container 80 of the fuel injection system via the throttle restriction 86 and the relief line 88, bypassing the magnet valve 8. In the basic state shown in FIG. 4, the pressure booster 5 is not active; that is, no pressure boosting is occurring. By means of the restoring spring 17, the piston 12 is returned to its outset position. Filling of the high-pressure chamber 20 is effected, in the open direction of the check valve 24, counter to the closing element 26, which is acted upon by a spring element 27 inside the check valve 24 and is supplied through the line 19 between the magnet valve 8 and the differential pressure chamber 16 of the pressure booster 5. By means of the pressure prevailing in the first nozzle spring element 82, which corresponds to the pressure prevailing in the high-pressure reservoir 2, a hydraulic closing force is exerted on the first nozzle needle part 31, that is, the outer part of the coaxial nozzle needle 30. In addition, via the spring elements 38 and 39, a closing spring force is exerted on the first nozzle needle part 31 and the further, second nozzle needle part 32, respectively. For this reason, the pressure level prevailing in the high-pressure reservoir 2 can always be present in the nozzle chamber 29, without opening of the first nozzle needle part 31 having occurred. Not until the pressure inside the nozzle chamber 29 rises above the pressure level of the high-pressure reservoir 2, which is attained by activation of the pressure booster 5, does the first nozzle needle part 31 open and the injection begin.

The metering of the fuel is effected by means of the pressure relief of the differential pressure chamber 16, analogously to the variant embodiments of FIGS. 1 and 2. This is effected by an activation of the magnet valve 8, embodied for instance as a 3/2-way control valve. A disconnection of the differential pressure chamber 16 of the pressure booster 5 and from the system pressure, that is, the pressure level prevailing in the high-pressure reservoir 2, and a communication of the differential pressure chamber 16 with the return 9 to the fuel container 80, or in other words to the low-pressure side are effected. The pressure in the differential pressure chamber 16 decreases, and as a result the pressure booster 5 is activated, and via an increase in the pressure level in the high-pressure chamber 20, an increase in the pressure in the nozzle chamber 29 is effected, which in turn acts on the hydraulic surface area 35 of the first nozzle needle part 31 and causes its upward motion counter to the spring force of the spring element 38 in the opening direction. As long as the differential pressure chamber 16 of the pressure booster 5 is pressure-relieved, the pressure booster 5 remains activated and compresses the fuel in the high-pressure chamber 20. The compressed fuel flows from there to the nozzle needle, that is, to the nozzle chamber 29, and from there via the annular gap 50 in the direction of the end toward the combustion chamber of the first and second nozzle needle part 31 and 32. The first nozzle spring element 82 remains pressure-relieved, but at the needle tip of the second nozzle needle part 32, an injection pressure level builds up. As a result, a pressure force acting in the opening direction of the second nozzle needle part 32 is established at the hydraulically effective surface area 40 (pressure shoulder) at the tip of the second nozzle needle part 32. Since the second nozzle spring element 83 associated with the second nozzle needle part 32 is still pressure-relieved as before, the spring elements 39 follow as a closing force on the second nozzle needle part 32. By way of suitable dimensioning of the pressure shoulder 80 relative to the closing force of the spring element 39, a switching pressure beyond which the inner, second nozzle needle part 32, guided in the coaxial nozzle needle 30, opens can be established, analogously to what the variant embodiment in FIG. 1 shows. If the injection pressure is low, below the switching pressure that can be set, the first nozzle needle part 31 opens, while the second nozzle needle part 32 remains closed. Accordingly, an injection is effected via the first injection cross section 42. As the injection pressure increases further above the switching pressure of the second nozzle needle part 32, the second nozzle needle part 32 opens in addition to the already-open first nozzle needle part 31, and as a result an injection into the combustion chamber 7 of the engine is effected via both the first injection cross section 42 and the further, second injection cross section 43.

The termination of the injection is brought about by means of the magnet valve 8, by way of which the differential pressure chamber 16 of the pressure booster 5 and the first nozzle spring element 82 are disconnected from the return side 9 of the magnet valve 8 and made to communicate with the supply pressure, that is, the pressure level prevailing in the high-pressure reservoir 2. Thus the pressure level prevailing in the high-pressure reservoir 2 builds up in the differential pressure chamber 16, and as a result a pressure relief in the high-pressure chamber 20 of the pressure booster 5 to the rail pressure level is established. Since the rail pressure level also prevails in the first nozzle spring element 82, the first nozzle needle part 31 is now in equilibrium in terms of the hydraulic forces, and it is actuated only via the spring force of the spring element 39, or in other words is closed. As a result of the uninterrupted delivery of fuel to the second nozzle needle part 32, the pressure level below the needle tip of the second nozzle needle part 32 drops very rapidly; that is, the second nozzle needle part 32 begins to close in response to the action of the spring force of the spring element 38. The injection is thus terminated. The closing speed established relative to the second nozzle needle part 32 can be varied by way of the design of the throttle restrictions 85 and 86.

To avoid leakage flows through the nozzle holes, a relief line in the form of a bore 84 is passed through the second nozzle needle part 32 and extends from a recess 48 into the second nozzle control chamber 83. In the variant embodiment shown in FIG. 1, the following three reference leakage flows ensue in the state of repose, that is, when the rail pressure level is applied in the closing chamber 21 and in the nozzle control chamber 29. Between the injector body, that is, its part toward the combustion chamber, and the first nozzle needle part 31, which is embodied with the diameter d₁, a first reference leakage flow between the nozzle chamber 29 and the leak fuel groove 46 and a reference leakage flow between the closing chamber 21 and the leak fuel groove 46 are established, while on the other hand a further leakage flow is established between the first nozzle needle part 31 and the second, inner nozzle needle part 32 in terms of FIG. 1, and this further reference leakage flows away into the leak fuel line 49 via the leak fuel groove 48, which is embodied on the inner part of the coaxial nozzle needle 30. The second nozzle needle part 32 is embodied with a diameter d₂, which may be between 2 and 2.5 mm, while the first nozzle needle part 31 is embodied with an outer diameter d₁ that may be between 4 and 4.5 mm. Thus two reference leakage flows occur at the large diameter d₁, and one reference leakage flow occurs at the small diameter d₂. In the variant embodiment that is shown in FIG. 4, a leak fuel groove 48 is analogously also received between the second nozzle needle part 32 and the first nozzle needle part 31 surrounding it, and this leak fuel groove may communicate with the longitudinal bore 84 by way of which the leak fuel can be carried away. A first reference leakage flow occurs with the small diameter d₁ between the nozzle chamber 29 and the leak fuel groove 48. A second reference leakage flow also occurs with the small diameter d₂ between the nozzle control chamber 82 and the leak fuel groove 48. Because of the smaller diameter of the second nozzle needle part 32, of 2 to 2.5 mm, a marked reduction can be attained with this variant embodiment, compared to leak fuel volume flows previously.

### List of Reference Numerals

1 Fuel injector
2 High-pressure reservoir
3 First throttle restriction
4 Line
5 Pressure booster
6 Injection valve
7 Combustion chamber of internal combustion engine
8 Magnet valve (3/2-way valve)
9 Low-pressure-side return
10 Housing of pressure booster
11 Pressure chamber
12 Piston
13 First partial piston
14 Second partial piston
15 Attachment of second partial piston
16 Differential pressure chamber
17 Restoring spring
18 Lead line to magnet valve
19 Fuel line, differential pressure chamber
20 High-pressure chamber
21 Closing chamber
22 Differential pressure chamber line to closing chamber
23 Second throttle restriction
24 Check valve
24.1 Throttle restriction
25 Check valve line
26 Closing element
27 Spring element of the check valve
28 High-pressure line, nozzle chamber
29 Nozzle chamber
30 Coaxial nozzle needle
31 First nozzle needle part
32 Second nozzle needle part
33 Stroke stop for first nozzle needle part
34 Stroke limitation for second nozzle needle part
35 Pressure shoulder of first nozzle needle part
36 End face of first nozzle needle part
37 End face of second nozzle needle part
38 Spring element of first nozzle needle part
39 Spring element of second nozzle needle part
40 Pressure shoulder of second nozzle needle part
41 Vario injection nozzle
42 First injection cross section
43 Second injection cross section
44 Face toward combustion chamber of injector housing
45 End face of first nozzle needle part
46 Leak fuel groove of first nozzle needle part
47 Leak fuel conduit
48 Leak fuel groove of second nozzle needle part
49 Leak fuel line
50 Annular gap
60 High-pressure branch from high-pressure reservoir 2
70 Pressure courses of nozzle chamber and high-pressure chamber
71 Pressure course of differential pressure chamber
t₁ triggering instant
t₂ triggering instant
t₃ triggering instant
t₄ triggering instant
72 Stroke course of first nozzle needle part
73 Stroke course of second nozzle needle part
74 First flow cross section
75 Second flow cross section
80 Fuel tank
81 Regulated pump assembly
82 First nozzle control chamber
83 Second nozzle control chamber
84 longitudinal bore
85 throttle restriction of first nozzle control chamber
86 throttle restriction of second nozzle control chamber
87 Stop toward needle
88 Relief lines, differential pressure chamber
89 Sleevelike body

1-25. (canceled)

26. In a fuel injection system for internal combustion engines, having a fuel injector (1) that can be supplied from a high-pressure fuel source (2, 81), in which between an injection valve (6) and the high-pressure fuel source (2, 81) a pressure booster (5) is disposed that has a booster piston (12), which separates a pressure chamber (11), which can be connected to the high-pressure fuel source (2, 81), from a high-pressure chamber (20) acting upon a nozzle chamber (29) of the fuel injector (1), a differential pressure chamber (16) of the pressure booster (5) in which a pressure change causes a pressure change in the high-pressure chamber (20), and the injection valve (6) includes a nozzle needle (30), with which injection openings oriented toward a combustion chamber (7) can be opened or closed, the improvement wherein the nozzle needle (30) comprises a first nozzle needle part (31) and a further nozzle needle part (32), the first and further nozzle needle parts being triggerable as a function of pressure to open and close various injection cross sections (42, 43) of an injection nozzle (41), wherein the nozzle needle parts (31, 32) of the nozzle needle (30) are guided one inside the other, and wherein the first nozzle needle part (31) and the second nozzle needle part (32) can be acted upon with fuel pressure counter to the action of closing springs (38, 39) via a first nozzle control chamber (82) that can be acted upon with fuel pressure with the interposition of a throttle restriction (85).

27. The fuel injection system of claim 26, wherein the nozzle needle parts (31, 32) of the nozzle needle (30) have surface areas (35, 40) that make a hydraulic pressure actuation possible.

28. The fuel injection system of claim 27, wherein the first nozzle needle part (31) includes a pressure shoulder (35), which is actuatable via the fuel, at high pressure, entering a nozzle chamber (29).

29. The fuel injection system of claim 27, wherein the second nozzle needle part (32) includes a pressure shoulder (40), which is disposed on its end toward the combustion chamber.

30. The fuel injection system of claim 27, further comprising a hydraulic chamber that, via a pressure shoulder (40) actuates the second nozzle needle part (32), is defined by an end face (45) of the first nozzle needle part (31) and a nozzle body face (44) toward the combustion chamber.

31. The fuel injection system of claim 30, wherein the nozzle body face (44) toward the combustion chamber is embodied conically.

32. The fuel injection system of claim 30, wherein the hydraulic chamber surrounds the pressure shoulder (40) of the second nozzle needle part (32) and is acted upon by fuel from the nozzle chamber (29) via an annular gap (50) when the first nozzle needle part (31) is actuated in the opening direction.

33. The fuel injection system of claim 26, further comprising stroke-limiting stops (33, 34) disposed in a closing chamber (21), the stops (33, 34) being associated with the first nozzle needle part (31) and the second nozzle needle part (32), and wherein at least one of the nozzle needle parts (31, 32) is acted upon a closing spring element (38, 39).

34. The fuel injection system of claim 26, wherein the first nozzle needle part (31) opens and closes a first injection cross section (42), and the second nozzle needle part (32) opens and closes a second injection cross section (43).

35. The fuel injection system of claim 34, wherein, after the opening of the first injection cross section (42) by the first nozzle needle part (31) upon pressure-dependent actuation of the second nozzle needle part (32), the second injection cross section (43) is opened in addition to the first injection cross section (42).

36. The fuel injection system of claim 34, wherein the first and second injection cross sections (42, 43) are embodied as concentric circles of holes on the end toward the combustion chamber of a nozzle body (44) of the fuel injector (1).

37. The fuel injection system of claim 34, wherein the first nozzle needle part (31) and the second nozzle needle part (32) each have respective leak fuel drainage recesses (46, 48) on their circumference.

38. The fuel injection system of claim 37, wherein the leak fuel drainage recesses (46, 48) communicate via a leak fuel conduit (47) that is provided in one of the nozzle needle parts (31, 32) and discharge into a leak fuel line (49) toward the housing.

39. The fuel injection system of claim 26, wherein the pressure-booster (5) comprises a pressure chamber (11), which is acted upon via a line (4) from the high-pressure fuel source (2, 81), a differential pressure chamber (16) which is in communication with the high-pressure fuel source (2, 81) via a magnet valve (8) in lines (18, 19), and a high-pressure chamber (20), which subjects a nozzle chamber (29), surrounding the coaxial nozzle needle (30), to high pressure.

40. The fuel injection system of claim 39, wherein the differential pressure chamber (16) of the pressure booster (5) communicates with a closing chamber (21) of the injection valve (6).

41. The fuel injection system of claim 39, wherein the closing chamber (21) of the injection valve (6) is acted directly upon by pressure from the high-pressure fuel source (2, 81) via a line (4, 60).

42. The fuel injection system of claim 40, wherein the closing chamber (21) of the injection valve (6) is acted upon by pressure through a line (25) parallel to a line (22) from the differential pressure chamber (16) or parallel to a line (60) from the high-pressure fuel source (2, 81), the line (25) including a check valve/throttle restriction (24) and being supplied from the high-pressure chamber (20).

43. The fuel injection system of claim 26, wherein the differential pressure chamber (16) of the pressure booster (5) communicates with a closing chamber (21) of the injection valve (6), wherein the closing chamber (21) of the injection valve (6) is acted upon by pressure through a line (25) parallel to a line (22) from the differential pressure chamber (16) or parallel to a line (60) from the high-pressure fuel source (2, 81), the line (25) including a check valve/throttle restriction (24) and being supplied from the high-pressure chamber (20) and wherein, when the valve (8) is deactivated, a fluidic communication (4, 18, 19, 22, 60, 23, 85) is established from the high-pressure source (2, 81) to the closing chamber (21, 82).

44. The fuel injection system of claim 26, wherein the differential pressure chamber (16) of the pressure booster (5) communicates with a closing chamber (21) of the injection valve (6), wherein the closing chamber (21) of the injection valve (6) is acted upon by pressure through a line (25) parallel to a line (22) from the differential pressure chamber (16) or parallel to a line (60) from the high-pressure fuel source (2, 81), the line (25) including a check valve/throttle restriction (24) and being supplied from the high-pressure chamber (20) and wherein, when the valve (8) is deactivated, a fluidic communication (4, 18, 19, 22; 60, 23, 85, 25, 28) is established from the high-pressure source (2) to the nozzle chamber (29).

45. The fuel injection system of claim 30, wherein at least the first nozzle needle part (31) can be acted upon by pressure that can be generated in the closing pressure chamber (21, 82).

46. The fuel injection system of claim 27, wherein independently of said surface areas (35, 40) the second nozzle needle part (32) can be actuated via a pressure relief of a second nozzle control chamber (83).

47. The fuel injection system of claim 46, wherein the second nozzle control chamber (83) is sealed off from the nozzle control chamber (82) by a sleevelike body (89).

48. The fuel injection system of claim 46, wherein the second nozzle needle part (32) comprises a longitudinal conduit (84), by way of which reference leakage is diverted into the second nozzle control chamber (83) and a relief line (88).

49. The fuel injection system of claim 47, wherein the reference leakage flows away into the nozzle control chamber (83) between the first and second needle parts (31, 32) via the longitudinal conduit (84) between the sleevelike body (89) and the inner needle part (32).
